(19) United States
(12) Patent Application Publication
(10) Pub. No.: US 2018/0231799 A1
(43) Pub. Date: Aug. 16, 2018

(54) FLOATABLE SPECTACLE FRAME STRUCTURE

(71) Applicant: HSIEN CHANG OPTICAL INDUSTRIAL CO., LTD., Tainan (TW)

(72) Inventor: WEN-HSIUNG CHOU, TAINAN (TW)

(21) Appl. No.: 15/429,544

(22) Filed: Feb. 10, 2017

(51) Int. Cl. G02C 5/00; G02C 5/02

(52) U.S. Cl. CPC G02C 5/008; G02C 2200/14; G02C 5/02

(57) ABSTRACT

A floatable spectacle frame structure is provided. The floatable spectacle frame structure mainly includes a spectacle frame body, a cover sheet, and a coating member. A space is disposed in the spectacle frame body. The opening end of the space is correspondingly assembled with the cover sheet. The coating member correspondingly coats on the external parts of the spectacle frame body and the cover sheet. Therefore, a gas-filling space is formed in the spectacle frame structure to let the spectacle frame float on water after falling into the water. Hence, the spectacle frame structure can be easily found.

### BACKGROUND

### Field of Invention

The disclosure relates to a floatable spectacle frame structure. More particularly, the disclosure relates to a floatable spectacle frame structure having a gas-filling space therein.

### Description of Related Art

Water activities include any sports, leisure and work activities in the water, at the water sides, and on the water. For example, water activities can be fishing, swimming, diving, water volleyball, surfing, water motorcycles, and even water ballet and so on. Since the water activities contribute to muscle activity, sweating, tendons and bones stretching, cardiopulmonary function enhancement, and other benefits, the water activities become causal hobbies of many people.

Because many people have myopia, hyperopia, astigmatism, or for shading purposes, or to avoid water into the eyes, they still need to wear eyeglasses when the water activities are in progress. However, when the water activities are too intense or people are inadvertent, eyeglasses may fall into water. Since the eyeglasses have a considerable density, the eyeglasses easily sink into the water and thus cannot be easily found. Therefore, it causes inconvenience for the users, and it even causes dangers.

Accordingly, Taiwan patent number M241662, structure of eyeglasses used in water activities, was granted. The eyeglasses comprise a frame part and a wearing part. The frame part comprises a frame body having lenses inserted into the inner edges of the frame body. The features include a hollow room disposed in the lens bodies, so that the lens bodies as well as the eyeglasses can have floatability on the water. The main design of eyeglasses is the hollow room disposed in the lens body. The hollow room is disposed between two clip layers of the lens, and the two clip layers are closely attached by a spacer frame made by a high airtight material. Or, the lens may be blown and then separated by the spacer frame to form the hollow room. Therefore, when a user is engaged in water activities and the eyeglasses fall into the water, the hollow lens allows the eyeglasses to float on the water. Hence, the user can find the eyeglasses quickly.

However, the main design of the eyeglasses in TW M241662 is the hollow room in the lens. Although the eyeglasses can float on water, the lenses cannot be easily made when the lenses, such as optical lenses, are used to correct myopia, hyperopia, and astigmatism. Thus, the eyeglasses disclosed in TW M241662 have the drawback of difficult production.

Therefore, in view of drawbacks of the conventional structures, the inventors develop this invention by the many-year manufacturing and design experience and knowledge in the related fields and ingenuity to provide a floatable spectacle frame structure to achieve more practical values.

### SUMMARY

An aspect of this invention is to provide a floatable spectacle frame structure. More particularly, the disclosure relates to a floatable spectacle frame structure having a gas-filling space therein.

The aspects and functions are mainly accomplished by the following technical means.

The floatable spectacle frame structure mainly comprises a spectacle frame body, a cover sheet, and a coating member. A space is disposed in the spectacle frame body. The opening end of the space is correspondingly assembled with the cover sheet. The coating member correspondingly coats on the external parts of the spectacle frame body and the cover sheet. Therefore, a gas-filling space is formed in the spectacle frame structure to let the spectacle frame float on water after falling into the water. Hence, the spectacle frame structure can be easily found.

In the floatable spectacle frame structure above, an opening of the space has a stepped rim disposed on the edge thereof to be inserted by the cover sheet.

In the floatable spectacle frame structure above, a nose bridge of the spectacle frame body has a convex part disposed thereon as well as coated and combined by the coating member to form nose pads.

In the floatable spectacle frame structure above, a top periphery of the spectacle frame body has a depressed portion disposed thereon, and the coating member combines the external parts of the depressed portion of the spectacle frame body and the cover sheet.

In the floatable spectacle frame structure above, the coating member is formed by injection coating to correspondingly combine the external parts of the spectacle frame body and the cover sheet.

In light of the foregoing described structure and embodiments of this invention, this invention has the following advantages, comparing with the conventional structure:

1. In the floatable spectacle frame structure of this invention, the space is designed in the spectacle frame body to form a gas-filling space therein. Therefore, the spectacle frame can float on water after the eyeglasses fall into the water, so that the user can easily find the eyeglasses.

2. In the floatable spectacle frame structure of this invention, the coating member is injected to surround the external parts of the spectacle frame body and the cover sheet, so that the temple body and the cover sheet can be tightly wrapped without falling off. Hence, the space therein can be sealed to have floating effect.

3. In the floatable spectacle frame structure of this invention, the coating member is injected to surround the external parts of the spectacle frame body and the cover sheet, so that the assembling procedure and the cost thereof can be saved.

### BRIEF DESCRIPTION OF THE DRAWINGS

FIG. 1 is a diagram showing a perspective decomposition of this invention.

FIG. 2 is a diagram showing a partial assembling appearance of this invention.

FIG. 3 is a diagram showing an overall appearance of this invention.

FIG. 4 is a diagram showing a cross-sectional view of this invention.

### DETAILED DESCRIPTION

To more completely and clearly illustrate the technical means and effects of this invention, the detailed descriptions are set forth below. Please refer to the disclosed figures and the reference numbers.

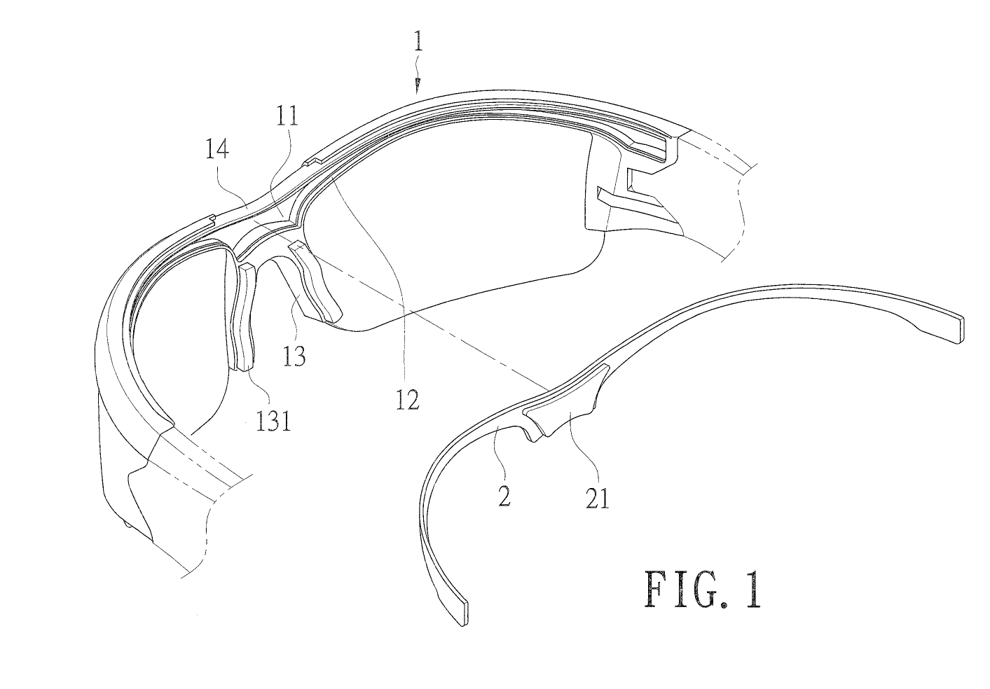

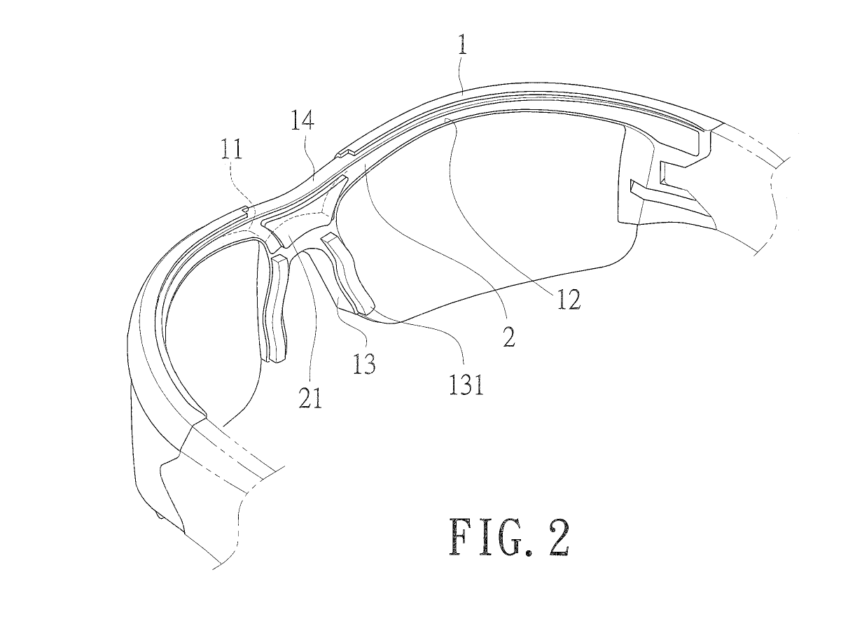

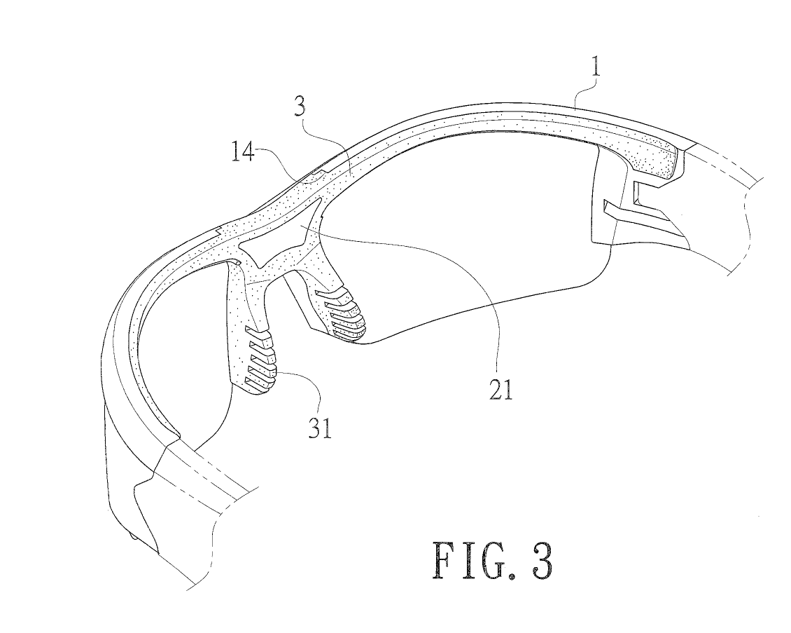

Please refer to FIGS. 1-3, which are a perspective view, a decomposed view, and an assembled appearance of a floatable spectacle frame structure according to an embodiment of this invention, respectively. The floatable spectacle frame structure mainly comprises:

a spectacle frame body 1 having a space 11 inside, wherein the opening of the space 11 has a stepped rim 12 disposed on the edge thereof, and the spectacle frame body 1 further has a nose bridge 13;

a cover sheet 2 inserted into the stepped rim 12 to seal the space 11; and

a coating member 3 correspondingly combining the external parts of the spectacle frame body 1 and the cover sheet 2 and forming nose pads 31 corresponding to the nose bridge 13.

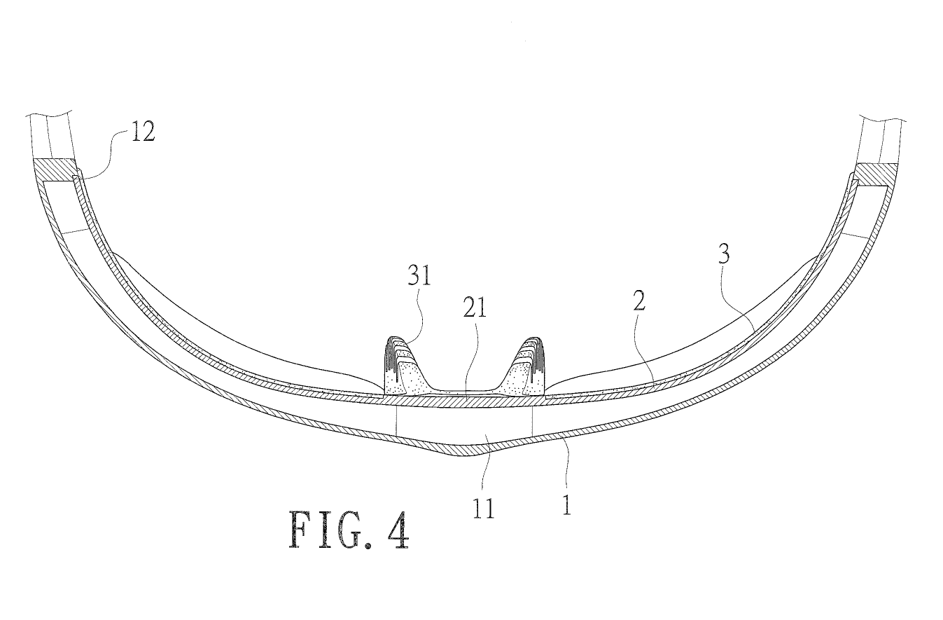

Please refer to FIGS. 1-4. When the floatable spectacle frame structure above is actually used, besides that the spectacle frame body 1 has the nose bridge 13 and the space 11 therein, a convex part 131 is disposed on the nose bridge 13 of the spectacle frame body 1. Further, the stepped rim 12 is disposed on the opening of the space 11 of the spectacle frame body 1. The stepped rim 12 is provided to be inserted by the cover sheet 2. Meanwhile, a depressed portion 14 is further disposed on the top periphery of the spectacle frame body 1. The coating member 3 is formed by injection coating to correspondingly combine the external parts of the depressed portion 14 of the spectacle frame body 1 and the cover sheet 2. The coating member 3 combine the external parts of the spectacle frame body 1 and the cover sheet 2, and cover the convex part 131 of the nose bridge 13 to form nose pads 31.

Moreover, a protrusion 21 is disposed on the external surface of the cover sheet 2 to increase the covering area of the coating member 3 on the external parts of the spectacle frame body 1 and the cover sheet 2. Hence, a good adhering effect can be satisfied.

In light of the described structure and embodiments of this invention above, this invention has the following advantages, comparing with the conventional structure:

1. In the floatable spectacle frame structure of this invention, the space is designed in the spectacle frame body to form a gas-filling space therein. Therefore, the spectacle frame can float on water after the eyeglasses fall into the water, so that the user can easily find the eyeglasses.

2. In the floatable spectacle frame structure of this invention, the coating member is injected to surround the external parts of the spectacle frame body and the cover sheet, so that the temple body and the cover sheet can be tightly wrapped without falling off Hence, the space therein can be sealed to have floating effect.

3. In the floatable spectacle frame structure of this invention, the coating member is injected to surround the external parts of the spectacle frame body and the cover sheet, so that the assembling procedure and the cost thereof can be saved.

What is claimed is:

1. A floatable spectacle frame structure, comprising:
a spectacle frame body having a space disposed therein and a nose bridge, wherein an edge of an opening of the space has a stepped rim disposed thereon;
a cover sheet inserted into the stepped rim to tightly seal the space; and
a coating member correspondingly combining the external parts of the spectacle frame body and the cover sheet as well as forming nose pads corresponding to the nose bridge.

2. The floatable spectacle frame structure of claim 1, wherein a top periphery of the spectacle frame body has a depressed portion disposed thereon, and the coating member combines the external parts of the depressed portion of the spectacle frame body and the cover sheet.

3. The floatable spectacle frame structure of claim 2, wherein the nose bridge of the spectacle frame body has a convex part disposed thereon as well as coated and combined by the coating member.

4. The floatable spectacle frame structure of claim 3, wherein an external surface of the cover sheet has a protrusion disposed thereon to increase a covering area of the coating member on the external parts of the spectacle frame body and the cover sheet.

5. The floatable spectacle frame structure of claim 4, wherein the coating member is formed by injection coating to correspondingly combine the external parts of the spectacle frame body and the cover sheet.
